(19) United States
(12) Patent Application Publication
(10) Pub. No.: US 2014/0211168 A1
(43) Pub. Date: Jul. 31, 2014

(54) IMAGE PROJECTION APPARATUS, CONTROL METHOD, RECORDING MEDIUM, AND PROJECTION SYSTEM

(71) Applicant: CANON KABUSHIKI KAISHA, TOKYO (JP)

(72) Inventors: Tomohiro Yano, Yokohama-shi (JP); Hironao Ito, Hiratsuka-shi (JP)

(73) Assignee: CANON KABUSHIKI KAISHA, TOKYO (JP)

(21) Appl. No.: 14/163,043

(22) Filed: Jan. 24, 2014

(30) Foreign Application Priority Data
Jan. 28, 2013 (JP) 2013-013733

(51) Int. Cl. G03B 21/26

(52) U.S. Cl. CPC G03B 21/26
USPC 353/30; 353/121

(57) ABSTRACT

An image projection apparatus obtains a first partial image, which is a part of a projection target image. The image projection apparatus also receives, from another image projection apparatus, a first overlap image that is a portion of an image corresponding to a predetermined overlap area in which a projected image that the image projection apparatus projects and a projected image projected by another image projection apparatus overlap with each other, and that is not included in the first partial image. Then, the image projection apparatus projects a combined image obtained by combining the received first overlap image and the first partial image.

### BACKGROUND OF THE INVENTION

1. Field of the Invention

The present invention relates to an image projection apparatus, a control method, a recording medium, and a projection system, and particularly to a technique for projecting one image using a plurality of image projection apparatuses.

2. Description of the Related Art

In recent years, with the increase in the number of pixels in an image sensor used in digital cameras and the like, the number of pixels in images available to users has also been increasing. To project an image with such a large number of pixels while maintaining high perceived resolution, an image forming device in an image projection apparatus, such as a liquid crystal projector, needs to have a large number of pixels. However, since image projection apparatuses having an image forming device with a large number of pixels are expensive, conventionally, a method is used in some cases by which one image is divided, and the divided images are projected as one image using a plurality of image projection apparatuses (Japanese Patent Laid-Open No. 2006-094186).

When images are projected as one image using a plurality of image projection apparatuses, in some cases a projection method is used by which a part of a projected image of each image projection apparatus is superimposed on that of another image projection apparatus in order to make a joint line of the projected images less remarkable. In this case, when the images (partial images), each being a part of an object image, projected by the image projection apparatuses are generated and input, an image input device needs to take an area (overlap area) in which the projected images are overlapped into consideration.

However, since the relationship regarding installation between the image projection apparatuses and a projection plane may possibly change, in some cases a user who operates the image input device is required to change the overlap area in accordance with the installation state, further generate a partial image, and input the partial image to the image projection apparatuses.

### SUMMARY OF THE INVENTION

The present invention was made in view of such problems in the conventional technique. The present invention provides an image projection apparatus, a control method, a recording medium, and a projection system that facilitate generation of an image to be input to each image projection apparatus when one projection target image is projected by overlapping projected images of a plurality of image projection apparatuses.

According to one aspect of the present invention, there is provided an image projection apparatus for projecting a projection target image by overlapping a projected image that the image projection apparatus projects with a projected image projected by another image projection apparatus on a projection plane, comprising: an obtaining unit which is able to obtain a first partial image that is a part of the projection target image; a reception unit which is able to receive, from the other image projection apparatus, a first overlap image that is a portion of an image corresponding to a predetermined overlap area in which the projected image that the image projection apparatus projects and the projected image projected by the other image projection apparatus overlap with each other, and that is not included in the first partial image; and a projection unit which is able to project a combined image obtained by combining the first overlap image received by the reception unit and the first partial image.

According to another aspect of the present invention, there is provided an image projection apparatus for projecting a projection target image by overlapping a projected image that the image projection apparatus projects with a projected image projected by another image projection apparatus on a projection plane, comprising: an obtaining unit which is able to obtain a partial image that is a part of the projection target image; a transmission unit which is able to transmit, to the other image projection apparatus, an overlap image that is a portion of an image corresponding to a predetermined overlap area in which the projected image that the image projection apparatus projects and the projected image projected by the other image projection apparatus overlap with each other, and that is included in the partial image; and a projection unit which is able to project the partial image.

According to still another aspect of the present invention, there is provided a method for controlling an image projection apparatus for projecting a projection target image by overlapping a projected image that the image projection apparatus projects with a projected image projected by another image projection apparatus on a projection plane, the method comprising: an obtaining step of obtaining a first partial image that is a part of the projection target image, by an obtaining unit in the image projection apparatus; a reception step of receiving, from the other image projection apparatus, a first overlap image that is a portion of an image corresponding to a predetermined overlap area in which the projected image that the image projection apparatus projects and the projected image projected by the other image projection apparatus overlap with each other, and that is not included in the first partial image, by a reception unit in the image projection apparatus; and a projection step of projecting a combined image obtained by combining the first overlap image received in the reception step and the first partial image, by a projection unit in the image projection apparatus.

According to yet another aspect of the present invention, there is provided a method for controlling an image projection apparatus for projecting a projection target image by overlapping a projected image that the image projection apparatus projects with a projected image projected by another image projection apparatus on a projection plane, the method comprising: an obtaining step of obtaining a partial image that is a part of the projection target image, by an obtaining unit in the image projection apparatus; a transmission step of transmitting, to the other image projection apparatus, an overlap image that is a portion of an image corresponding to a predetermined overlap area in which the projected image that the image projection apparatus projects and the projected image projected by the other image projection apparatus overlap with each other, and that is included in the partial image, by a transmission unit in the image projection apparatus; and a projection step of projecting the partial image, by a projection unit in the image projection apparatus.

According to still yet another aspect of the present invention, there is provided a projection system for projecting a projection target image by overlapping a first projected image projected by a first image projection apparatus and a second projected image projected by a second image projection apparatus with each other, on a projection plane, the first image projection apparatus comprising: a first obtaining unit which is able to obtain a first partial image that is a part of the projection target image; a reception unit which is able to receive, from the second image projection apparatus, a first overlap image that is a portion of an image corresponding to a predetermined overlap area in which the second projected image and the first projected image overlap with each other, and that is not included in the first partial image; and a first projection unit which is able to project a combined image obtained by combining the first overlap image received by the reception unit and the first partial image, the second image projection apparatus comprising: a second obtaining unit which is able to obtain a second partial image that is a part of the projection target image; a transmission unit which is able to transmit, to the first image projection apparatus, an image that is a portion of the image corresponding to the overlap area and is included in the second partial image, as the first overlap image; and a second projection unit which is able to project the second partial image.

Further features of the present invention will become apparent from the following description of exemplary embodiments (with reference to the attached drawings).

### BRIEF DESCRIPTION OF THE DRAWINGS

FIG. 1 is a block diagram showing a functional configuration of a liquid crystal projector according to an embodiment of the present invention.

FIG. 2 is a block diagram showing a system configuration of a projection system according to an embodiment of the present invention.

FIGS. 3A and 3B are diagrams for illustrating overlap images to be transmitted that are generated by a transmission image generation unit 105 in the liquid crystal projector according to an embodiment of the present invention.

FIGS. 4A and 4B are diagrams for illustrating images to be projected that are generated by a combining unit 107 in the liquid crystal projector according to an embodiment of the present invention.

FIGS. 5A and 5B are diagrams for illustrating luminance adjustment processing performed by an image processing unit 108 in the liquid crystal projector according to an embodiment of the present invention.

FIG. 6 is a flowchart illustrating exemplary projection processing executed by a liquid crystal projector according to Embodiment 1 of the present invention.

FIG. 7 is a flowchart illustrating exemplary projection processing executed by a liquid crystal projector according to Embodiment 2 of the present invention.

### DESCRIPTION OF THE EMBODIMENTS

### Embodiment 1

Hereinafter, exemplary embodiments of the present invention will be described in detail with reference to the drawings. Note that in the following embodiments, an example will be described in which the present invention is applied to a liquid crystal projector 100 and a liquid crystal projector 200, each serving as an exemplary image projection apparatus and capable of transmitting and receiving images to be projected to/from each other. However, the present invention is applicable to any devices capable of transmitting and receiving images to be projected to/from each other.

In the present specification, a “projection target image” refers to an image of a projection target to be projected on a projection plane. The projection target image is obtained as a result of a group of projected images projected on a projection plane by a plurality of image projection apparatuses being appropriately arranged on the projection plane, and thus the corresponding projected images being formed on the projection plane. At this time, the projected image projected by each image projection apparatus is partially superimposed on a projected image projected by at least one of the other image projection apparatuses on the projection plane, and a border between the projected images are thereby made less remarkable. That is to say, an image to be ultimately projected as a projected image by each image projection apparatus is partially superimposed on an image projected by at least one of the other image projection apparatuses.

In the present specification, a “partial image” refers to an image that is input to each image projection apparatus (liquid crystal projector). The partial image is an image corresponding to a partial area in a projection target image, and is distinguished from the projection target image in the following description.

Functional Configuration of Liquid Crystal Projector

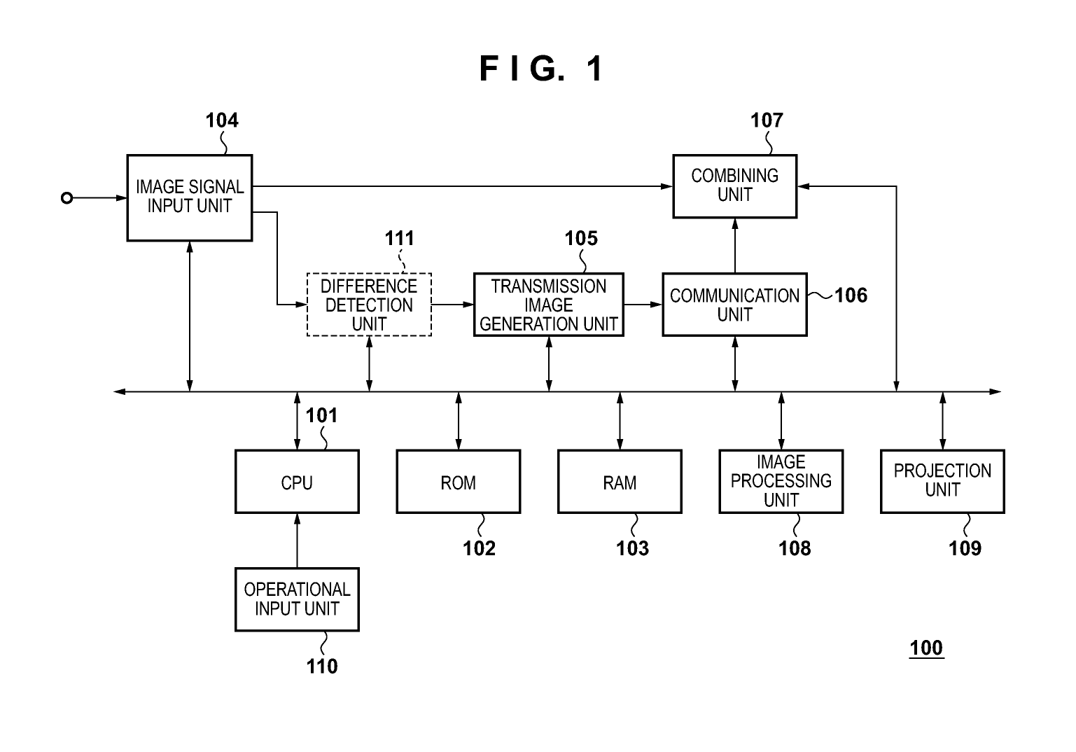

FIG. 1 is a block diagram showing a functional configuration of a liquid crystal projector 100 according to an embodiment of the present invention. A liquid crystal projector 100 and a liquid crystal projector 200 in the present embodiment have the same configuration, and accordingly, only the configuration of the liquid crystal projector 100 will be illustrated in FIG. 1.

A CPU 101 controls operations of blocks included in the liquid crystal projector 100. Specifically, the CPU 101 controls the operations of the blocks by reading out operation programs for the respective block stored in a ROM 102, and deploying and executing the operation programs in a RAM 103.

The ROM 102 is a rewritable nonvolatile memory, for example. The ROM 102 stores operation programs for the blocks included in the liquid crystal projector 100, as well as information such as necessary parameters for the operations of the blocks. The RAM 103 is a volatile memory. The RAM 103 is used not only as an area in which the operation programs for the blocks are deployed, but as a storage area in which intermediate data that is output during the operations of the blocks and the like are stored.

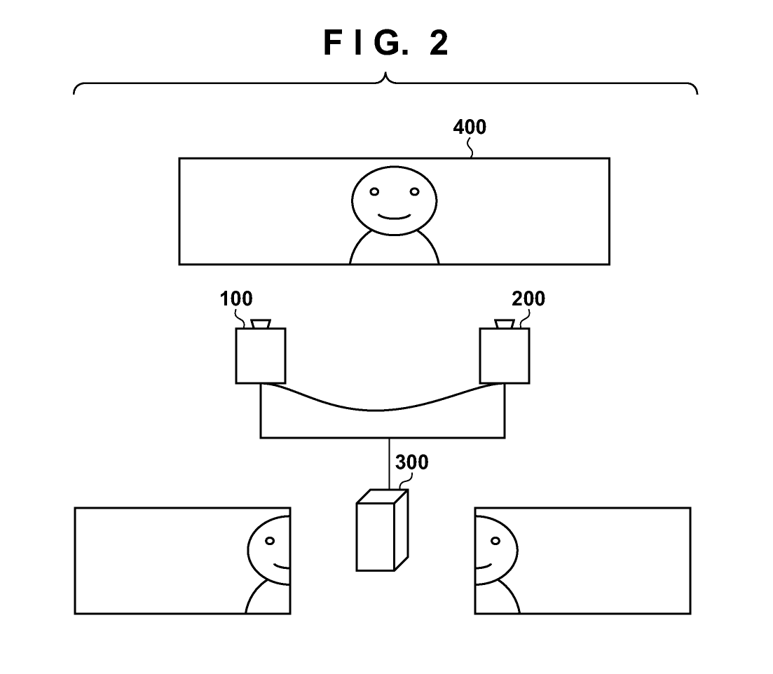

An image signal input unit 104 is an input interface included in the liquid crystal projector 100 for accepting input (first obtaining, second obtaining) of a partial image of a projection target image. The image signal input unit 104 converts an input image signal into image data and outputs the image data to the transmission image generation unit 105 and a combining unit 107. In the present embodiment, the image signal input unit 104 in the liquid crystal projector 100 and the liquid crystal projector 200 accepts input of a partial image of a projection target image from an input device 300 in the projection system, as shown in FIG. 2. The projection target image is projected as a projected image 400 on a projection plane by the liquid crystal projector 100 and the liquid crystal projector 200.

In the present embodiment, the partial images that are input from the input device 300 to the respective projectors are images obtained by dividing the projection target image into two along the center line. That is to say, the partial images that are input to the respective projectors for projecting the projection target image in the present embodiment do not overlap with each other, unlike the conventional ones. Note that although images corresponding to adjacent areas obtained by dividing the projection target image along the center line are input as the partial images in the description of the present embodiment, the implementation of the present invention is not limited thereto. The images that are input to the projectors need only be images obtained by dividing the projection target image into the number of projectors that are used in projection such that the divided images do not overlap with one another.

The transmission image generation unit 105 extracts an image to be projected by the other image projection apparatus, i.e., the liquid crystal projector 200, from the partial image that was input by the image signal input unit 104. In the liquid crystal projector 200, the transmission image generation unit 105 extracts an image to be projected by the liquid crystal projector 100 from the input partial image.

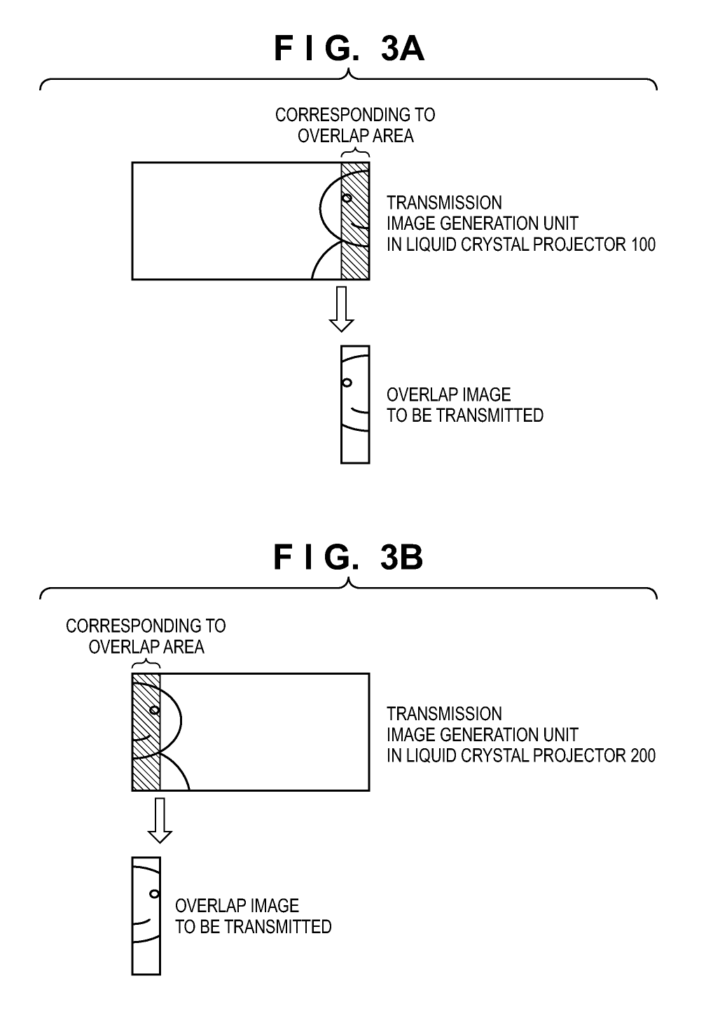

The liquid crystal projectors in the present embodiment do not require that the input partial image, when projected, is an image including an entire overlap area in which the partial image overlaps the other projected image. That is to say, the partial image does not need to be identical to the projected image to be ultimately projected by each liquid crystal projector, and the partial images are generated by simply dividing the projection target image into two in the input device 300, as described above. For this reason, the transmission image generation unit 105 generates an image (overlap image) to be transmitted, which is a portion of the image corresponding to the overlap area in the projection target image and is also projected by the other liquid crystal projector. That is to say, as shown in FIGS. 3A and 3B, for example, the transmission image generation unit 105 extracts the image that is not included in the partial image input to the other liquid crystal projector as an overlap image to be transmitted, and outputs this overlap image to an communication unit 106, which will be described later. Information about the image that is a portion of the partial image and corresponds to the overlap area can be set by the user using an operational input unit 110, which will be described later, for example. The set information about the image corresponding to the overlap area is stored in the ROM 102, read out by the transmission image generation unit 105, and used to generate the overlap image to be transmitted, for example. Note that although the information about the image corresponding to the overlap area is set in the liquid crystal projector 100 or the liquid crystal projector 200 by the user in the description of the present embodiment, the implementation of the invention according to the present embodiment is not limited thereto. This information may be set in one liquid crystal projector within the same network and shared with another liquid crystal projector within the network, for example. Alternatively, the information may be supplied from the input device 300 that inputs the partial images to the respective liquid crystal projectors, for example.

The communication unit 106 is a communication interface included in the liquid crystal projector 100. In the present embodiment, the liquid crystal projector 100 is communicably connected to the other liquid crystal projector and the input device 300 via the communication unit 106, as shown in FIG. 2. It could be easily imagined that communication connection among the devices is not limited to wired connection, and may also be wireless connection. The communication unit 106 transmits the image to be transmitted that was input from the transmission image generation unit 105, to the other connected liquid crystal projector. The communication unit 106 also receives an image transmitted from the other liquid crystal projector and outputs the transmitted image as an overlap image to be combined to the combining unit 107.

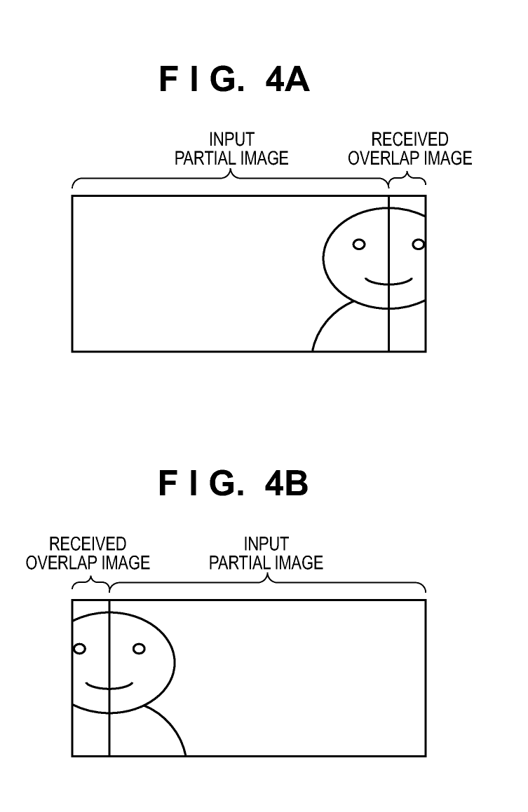

The combining unit 107 combines the partial image that was input from the image signal input unit 104 and the overlap image to be combined that was input from the communication unit 106, generates a combined image to be projected, and outputs the generated combined image to the image processing unit 108. Specifically, as shown in FIGS. 4A and 4B, the combining unit 107 combines the partial image and the overlap image to be combined in accordance with their positional relationship in the projection target image, and thereby generates the combined image to be projected.

The image processing unit 108 applies image processing for projection, such as keystone correction and image quality enhancing processing, to the input image. The image processing unit 108 also applies so-called edge-blending luminance adjustment processing to the image that is a portion of the input image and corresponds to the overlap area that overlaps with the other projected image when projected.

In the overlap area in which the projected images are superimposed on each other, the brightness of the overlap area increases due to superimposition, compared with the case where projection is performed by one image projection apparatus. For this reason, in the present embodiment, the image processing unit 108 performs adjustment for reducing the luminance of the image that is a portion of the combined image to be projected and corresponds to the overlap area. This luminance adjustment processing realizes edge-blending with which the difference in the brightness between the overlap area and the non-overlap area is less remarkable when projected.

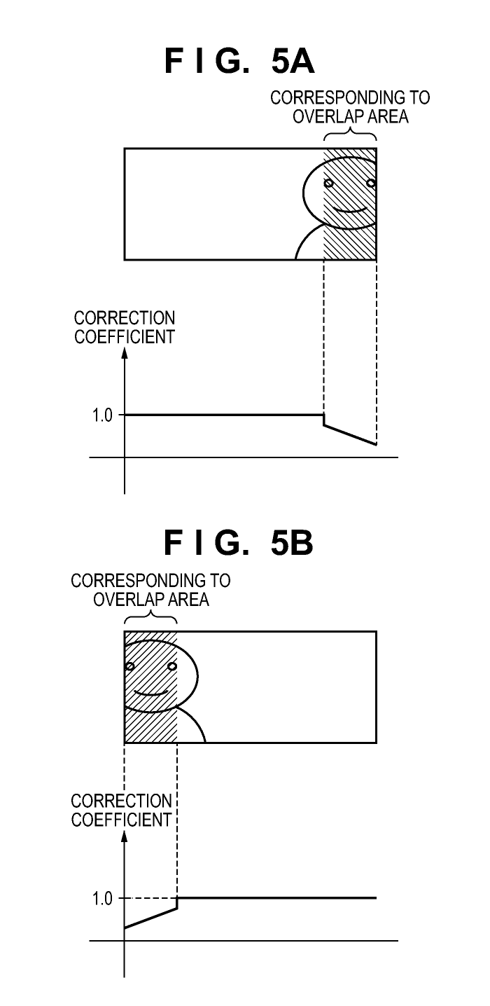

The luminance adjustment processing is as shown in FIGS. 5A and 5B in the case where the partial images obtained by dividing the projection target image into two images that are adjacent horizontally are projected by the liquid crystal projectors, for example. Specifically, for the image to be projected on the left of the projection plane, the image processing unit 108 does not perform the luminance correction on the image corresponding to the non-overlap area, as shown in FIG. 5A (correction coefficient 1.0). On the other hand, the image processing unit 108 performs the luminance adjustment from the border between the non-overlap area and the overlap area to the right edge of the image to be projected by gradually reducing the correction coefficient toward the right in the horizontal direction, for example. Similarly, for the image to be projected on the right of the projection plane, the image processing unit 108 does not perform the luminance adjustment on the image corresponding to the non-overlap area, as shown in FIG. 5B. On the other hand, the image processing unit 108 performs the luminance adjustment from the border between the non-overlap area and the overlap area to the left edge of the image to be projected by gradually reducing the correction coefficient toward the left in the horizontal direction, for example. The correction coefficient is changed when projected images of pixels at the same positions in the projection target image are superimposed on each other, such that the luminance is substantially equal to the luminance when the correction coefficient is 1.0.

A projection unit 109 is constituted by a liquid crystal panel, a light source, and a control unit of these components. The projection unit 109 controls the light transmittance of the pixels in the liquid crystal panel in accordance with the image to be projected to which the image processing was applied by the image processing unit 108, and thereby forms the projected image corresponding to the image to be projected on the projection plane with light radiated from the light source.

The operational input unit 110 is a user interface, such as various kinds of button or an infrared ray receiving unit, included in the liquid crystal projector 100. When the operational input unit 110 detects an operation made by the user, or an operation performed by the user using a remote controller, the operational input unit 110 transmits a control signal corresponding to the content of the operation to the CPU 101.

Projection Processing

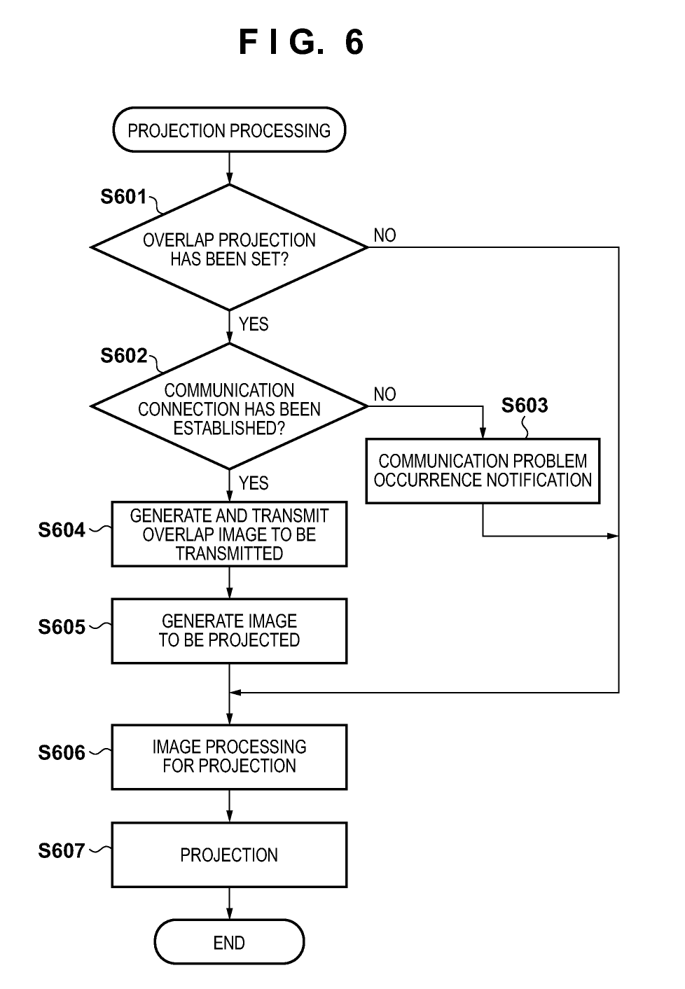

Specific projection processing performed by the liquid crystal projector 100 or the liquid crystal projector 200 in the present embodiment having the above-described configuration will now be described using the flowchart in FIG. 6. The processing corresponding to this flowchart can be realized by the CPU 101 reading out a corresponding processing program stored in the ROM 102 and deploying and executing the processing program in the RAM 103, for example. Note that in the following description, this projection processing is started when a partial image is input from the input device 300, for example.

In step S601, the CPU 101 determines whether or not a projection setting for overlapping projected images has been configured. For example, the CPU 101 performs the determination based on whether or not information about the image corresponding to the overlap area has been set. If the CPU 101 determines that the projection setting for overlapping the projected images has been configured, the CPU 101 advances the processing to step S602. If the CPU 101 determines that the projection setting for overlapping the projected images has not been configured, the CPU 101 sets the partial image that was input via the image signal input unit 104 as the image to be projected, and advances the processing to step S606.

In step S602, the CPU 101 determines whether or not communication connection with the other liquid crystal projector whose projected image is to be superimposed has been normally established. If the CPU 101 determines that the communication connection with the other liquid crystal projector has been normally established, the CPU 101 advances the processing to step S604. If the CPU 101 determines that the communication connection with the other liquid crystal projector has not been normally established, the CPU 101 notifies the user that a communication problem has occurred in step S603, thereafter sets the partial image that was input via the image signal input unit 104 as the image to be projected, and advances the processing to step S606.

In step S604, the CPU 101 causes the transmission image generation unit 105 to generate the overlap image to be transmitted, using the input partial image, and transmits the generated overlap image to the other liquid crystal projector via the communication unit 106.

In step S605, the CPU 101 transmits, to the combining unit 107, the partial image that was input via the image signal input unit 104 and the overlap image to be combined that was received via the communication unit 106, and causes the combining unit 107 to generate the image to be projected.

In step S606, the CPU 101 transmits the image to be projected to the image processing unit 108, and causes the image processing unit 108 to apply the image processing for projection. If the image to be projected is one that was generated by the combining unit 107 in step S605, the image processing unit 108 also performs the luminance adjustment processing on the image corresponding to the overlap area.

In step S607, the CPU 101 causes the projection unit 109 to project the projected image corresponding to the image to be projected that has been subjected to the image processing, and terminates the projection processing.

Note that in the above-described present embodiment, both images that are input to the liquid crystal projector 100 and the liquid crystal projector 200 include an image corresponding to the overlap area, and the liquid crystal projectors 100 and 200 transmit and receive the overlap image to/from each other. However, the implementation of the present invention is not limited thereto. The present invention is applicable to image projection apparatuses whose projected images are overlapped with each other, and one of which transmits, to the other image projection apparatus, an image that corresponds to an overlap area and is not input to the other image projection apparatus. In other words, in this case, the partial image to be input to the other image projection apparatus does not need to include the image corresponding to the overlap area, and all images corresponding to the overlap area may be transmitted from the one of the image projection apparatuses.

As described above, the image projection apparatus in the present embodiment can easily generate an image to be input to each image projection apparatus when one projection target image is projected by overlapping projected images of a plurality of image projection apparatuses. Specifically, the image projection apparatus obtains a first partial image, which is a part of the projection target image. The image projection apparatus also receives, from another image projection apparatus, a first overlap image that is a portion of an image corresponding to a predetermined overlap area in which a projected image that the image projection apparatus projects and a projected image projected by the other image projection apparatus overlap with each other, and that is not included in the first partial image. Then, the image projection apparatus projects a combined image obtained by combining the received first overlap image and the first partial image.

Thus, even if the partial images that are input from an input device to the respective image projection apparatuses do not include images that overlap with each other, an image to be projected that is preferable for edge-blending can be generated by transmitting and receiving the image corresponding to a preset overlap area between the image projection apparatuses.

### Embodiment 2

In the above description of Embodiment 1, an image corresponding to an overlap area is transmitted and received between the liquid crystal projectors. The present embodiment will be described regarding the implementation of the present invention in a mode in which the content of projection is frequently updated, such as in the case where a moving image is reproduced and frames thereof are projected.

For example, if the number of pixels in each frame in the moving image is large, the volume of the overlap image transmitted and received between the liquid crystal projectors is also large. Since the frames of a moving image are updated at predetermined time intervals, if an overlap image having a large volume is transmitted to another liquid crystal projector in units of frames, transmission delay may possibly occur depending on the communication bandwidth.

For example, a consideration is now given to the case where a second overlap image, which is a portion of a first partial image that was input to a liquid crystal projector 100 (first image projection apparatus) and which corresponds to an overlap area, is transmitted to a liquid crystal projector 200 (second image projection apparatus), and thereafter a change occurs in the image corresponding to the overlap area in the next frame. If reception of the second overlap image by the liquid crystal projector 200 is complete with a delay of the duration of one frame due to transmission delay, the following problem may possibly occur. A combined image to be projected that is generated in the liquid crystal projector 200 is an image obtained by combining an input second partial image and the second overlap image corresponding to the overlap area of the previous frame. That is to say, when a second projected image obtained by projecting this combined image and a first projected image projected by the liquid crystal projector 100 are superimposed on each other, at least the images corresponding to the second overlap image are different between the projected images and therefore cannot be superimposed on each other, which might give a viewer an impression that image quality has degraded. In the present embodiment, a description will be given of a method for preferably projecting a projection target image while avoiding occurrence of such data delay between the liquid crystal projectors.

Functional Configuration of Liquid Crystal Projector

The functional configuration of liquid crystal projectors 100 and 200 in the present embodiment is different from the configuration in the above-described embodiment in that a difference detection unit 111 is provided.

The difference detection unit 111 detects a difference between a partial image that is output from the image signal input unit 104 and a partial image of the previous frame, generates a difference image, and outputs the difference image to the transmission image generation unit 105. With the liquid crystal projector in the present embodiment, an input partial image for at least the duration of one frame is stored and held in the RAM 103. When the CPU 101 causes the difference detection unit 111 to perform the difference detection, the CPU 101 reads out the partial image of the previous frame from the RAM 103 and inputs the partial image to the difference detection unit 111.

Note that the transmission image generation unit 105 in the present embodiment extracts an image to be projected by the other image projection apparatus from the difference image generated by the difference detection unit 111. That is to say, the transmission image generation unit 105 extracts the image corresponding to the overlap area from the difference image, and generates the extracted image as an overlap image to be transmitted. In the present embodiment, since the portion where a change has occurs between frames is extracted from the difference image and used as the overlap image to be transmitted, the data volume of the overlap image that is transmitted and received between the liquid crystal projectors can be reduced. That is to say, the image that is transmitted between the liquid crystal projectors in the present embodiment can be an image of pixels or a block where a change has occurred in an image that corresponds to the overlap area and is not included in the partial image that was input to the other liquid crystal projector. For this reason, occurrence of data delay during transmission of the overlap image between the liquid crystal projectors can be suppressed.

Projection Processing

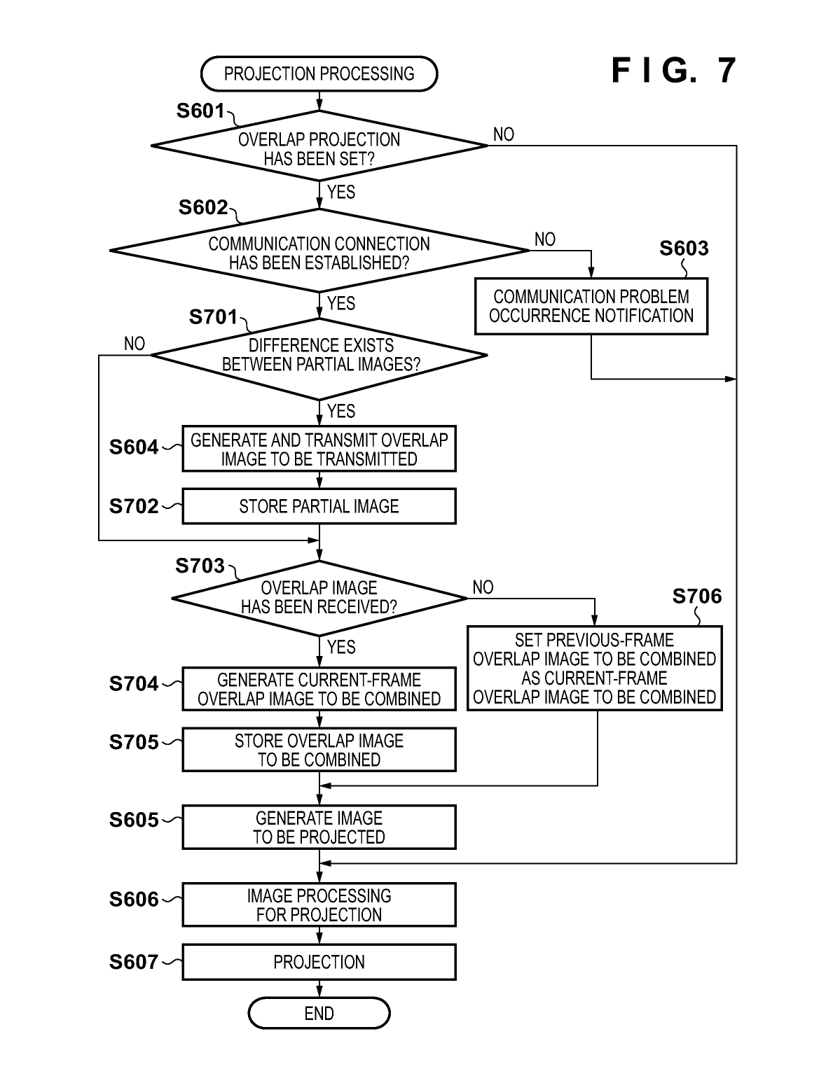

Specific projection processing performed by the liquid crystal projector 100 or the liquid crystal projector 200 in the present embodiment having the above-described configuration will now be described using the flowchart in FIG. 7. The processing corresponding to this flowchart can be realized by the CPU 101 reading out a corresponding processing program stored in the ROM 102 and deploying and executing the processing program in the RAM 103, for example. Note that in the following description, this projection processing is started when a partial image is input from the input device 300, for example. Further, in the following description, the steps in which the same processing as in Embodiment 1 is performed will be given the same reference numerals to omit the description thereof, and only the steps that is unique to the present embodiment will be described.

If it is determined in step S602 that communication connection with the other liquid crystal projector has been normally established, in step S701, the CPU 101 determines whether or not a change has occurred between the input partial image and the partial image that was input for the previous frame. Specifically, the CPU 101 transmits two types of partial image to the difference detection unit 111 and causes the difference detection unit 111 to detect a difference therebetween, and performs the aforementioned determination in accordance with the detection result. If the CPU 101 determines that a change has occurred between the input partial image and the partial image that was input for the previous frame, the CPU 101 advances the processing to step S604, and causes the transmission image generation unit 105 to generate an overlap image to be transmitted, using the difference image and transmit the generated overlap image. If the CPU 101 determines that a change has not occurred between the input partial image and the partial image that was input for the previous frame, the CPU 101 advances the processing to step S703.

After causing the transmission image generation unit 105 to generate the overlap image to be transmitted in step S604, the CPU 101 stores the partial image that was input in step S702 in the RAM 103, and advances the processing to step S703.

In step S703, the CPU 101 determines whether or not the overlap image (difference image) has been received from the other liquid crystal projector via the communication unit 106. If the CPU 101 determines that the overlap image has been received from the other liquid crystal projector, the CPU 101 advances the processing to step S704, and if the CPU 101 determines that the overlap image has not been received, the CPU 101 advances the processing to step S706.

In step S704, the CPU 101 transmits the overlap image (difference image) received via the communication unit 106 and the overlap image to be combined that was generated for the previous frame to the image processing unit 108, and generates a current-frame overlap image to be combined. Further, in step S705, the CPU 101 stores the overlap image to be combined that was generated in step S704 in the RAM 103, and advances the processing to step S605.

On the other hand, if it is determined in step S703 that the overlap image has not been received from the other liquid crystal projector, in step S706, the CPU 101 sets the overlap image to be combined that was generated for the previous frame as the current-frame overlap image to be combined, and advances the processing to step S605.

Then, in step S605, the CPU 101 transmits the current-frame overlap image to be combined and the input partial image to the combining unit 107, and causes the combining unit 107 to generate an image to be projected.

Thus, with the image projection apparatus in the present embodiment, occurrence of data delay during communication between the image projection apparatuses can be reduced, and a preferable projected image of the projection target image can be projected, even in the case where the projection target image is updated at predetermined time intervals.

Note that although the difference image can be transmitted within the duration of one frame in the description of the present embodiment, the implementation of the present invention is not limited thereto. For example, if data delay occurs with a small amount of delay when the difference image is transmitted, information for designating a projection timing may be transmitted and received between the apparatuses such that the same projected images of the overlap area are projected at the same timing, in order to avoid a discrepancy between the projected images of the image projection apparatuses. The information for designating the timing need only be transmitted to the other image projection apparatus together with the difference image, for example, and the CPU 101 in the image projection apparatus that received the information need only control the projection unit 109 such that the projected image is projected at the designated timing.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-013733, filed Jan. 28, 2013, which is hereby incorporated by reference herein in its entirety.

What is claimed is:

1. An image projection apparatus for projecting a projection target image by overlapping a projected image that the image projection apparatus projects with a projected image projected by another image projection apparatus on a projection plane, comprising:
an obtaining unit which is able to obtain a first partial image that is a part of the projection target image;
a reception unit which is able to receive, from the other image projection apparatus, a first overlap image that is a portion of an image corresponding to a predetermined overlap area in which the projected image that the image projection apparatus projects and the projected image projected by the other image projection apparatus overlap with each other, and that is not included in the first partial image; and
a projection unit which is able to project a combined image obtained by combining the first overlap image received by the reception unit and the first partial image.

2. The image projection apparatus according to claim 1,
wherein the other image projection apparatus obtains a second partial image that is a part of the projection target image and does not include the first partial image, and
the reception unit receives an image that is a portion of the image corresponding to the overlap area and included in the second partial image, as the first overlap image.

3. The image projection apparatus according to claim 2,
wherein the first partial image and the second partial image are images corresponding to adjacent areas in the projection target image.

4. The image projection apparatus according to claim 1,
wherein the reception unit receives the first overlap image at a predetermined time interval,
the first overlap image is received as a difference image indicating a difference from an image that is already received from the other image projection apparatus, and
the image projection apparatus further comprises a generation unit which is able to generate the first overlap image to be used in the combination, using the difference image obtained by the reception unit and the received image.

5. The image projection apparatus according to claim 1, further comprising:
a transmission unit which is able to transmit a second overlap image that is a portion of the image corresponding to the overlap area and included in the first partial image, to the other image projection apparatus.

6. The image projection apparatus according to claim 5,
wherein the obtaining unit obtains the first partial image at a predetermined time interval, and
when a new first partial image is obtained, the transmission unit transmits, to the other image projection apparatus, a difference image indicating a difference from an image that is already transmitted to the other image projection apparatus, as the second overlap image.

7. The image projection apparatus according to claim 5,
wherein the transmission unit transmits information for designating a projection timing for the second overlap image in the other image projection apparatus to the other image projection apparatus, together with the second overlap image.

8. The image projection apparatus according to claim 7,
wherein the projection timing in the other image projection apparatus indicates the same timing as a projection timing for the first partial image with respect to which the second overlap image was generated in the image projection apparatus.

9. The image projection apparatus according to claim 1, further comprising:
a setting unit which is able to set the overlap area, and
an adjustment unit which is able to perform luminance adjustment on an image that is a portion of the combined image and corresponds to the overlap image.

10. An image projection apparatus for projecting a projection target image by overlapping a projected image that the image projection apparatus projects with a projected image projected by another image projection apparatus on a projection plane, comprising:
an obtaining unit which is able to obtain a partial image that is a part of the projection target image;
a transmission unit which is able to transmit, to the other image projection apparatus, an overlap image that is a portion of an image corresponding to a predetermined overlap area in which the projected image that the image projection apparatus projects and the projected image projected by the other image projection apparatus overlap with each other, and that is included in the partial image; and
a projection unit which is able to project the partial image.

11. The image projection apparatus according to claim 10,
wherein the obtaining unit obtains the partial image at a predetermined time interval, and
when a new partial image is obtained, the transmission unit transmits, to the other image projection apparatus, a difference image indicating a difference from an image that is already transmitted to the other image projection apparatus, as the overlap image.

12. The image projection apparatus according to claim 10,
wherein the transmission unit transmits information for designating a projection timing for the overlap image in the other image projection apparatus to the other image projection apparatus, together with the overlap image.

13. The image projection apparatus according to claim 12,
wherein the projection timing in the other image projection apparatus indicates the same timing as a projection timing for the partial image with respect to which the overlap image was generated in the image projection apparatus.

14. The image projection apparatus according to claim 10, further comprising:
a setting unit which is able to set the overlap area, and
an adjustment unit which is able to perform luminance adjustment on an image that is a portion of the combined image and corresponds to the overlap image.

15. A method for controlling an image projection apparatus for projecting a projection target image by overlapping a projected image that the image projection apparatus projects with a projected image projected by another image projection apparatus on a projection plane, the method comprising:
an obtaining step of obtaining a first partial image that is a part of the projection target image, by an obtaining unit in the image projection apparatus;
a reception step of receiving, from the other image projection apparatus, a first overlap image that is a portion of an image corresponding to a predetermined overlap area in which the projected image that the image projection apparatus projects and the projected image projected by the other image projection apparatus overlap with each other, and that is not included in the first partial image, by a reception unit in the image projection apparatus; and
a projection step of projecting a combined image obtained by combining the first overlap image received in the reception step and the first partial image, by a projection unit in the image projection apparatus.

16. A method for controlling an image projection apparatus for projecting a projection target image by overlapping a projected image that the image projection apparatus projects with a projected image projected by another image projection apparatus on a projection plane, the method comprising:
an obtaining step of obtaining a partial image that is a part of the projection target image, by an obtaining unit in the image projection apparatus;
a transmission step of transmitting, to the other image projection apparatus, an overlap image that is a portion of an image corresponding to a predetermined overlap area in which the projected image that the image projection apparatus projects and the projected image projected by the other image projection apparatus overlap with each other, and that is included in the partial image, by a transmission unit in the image projection apparatus; and
a projection step of projecting the partial image, by a projection unit in the image projection apparatus.

17. A recording medium storing a program for causing a computer to function as each step in the image projection apparatus according to claim 1.

18. A projection system for projecting a projection target image by overlapping a first projected image projected by a first image projection apparatus and a second projected image projected by a second image projection apparatus with each other, on a projection plane,
the first image projection apparatus comprising:
a first obtaining unit which is able to obtain a first partial image that is a part of the projection target image;
a reception unit which is able to receive, from the second image projection apparatus, a first overlap image that is a portion of an image corresponding to a predetermined overlap area in which the second projected image and the first projected image overlap with each other, and that is not included in the first partial image; and
a first projection unit which is able to project a combined image obtained by combining the first overlap image received by the reception unit and the first partial image,
the second image projection apparatus comprising:
a second obtaining unit which is able to obtain a second partial image that is a part of the projection target image;
a transmission unit which is able to transmit, to the first image projection apparatus, an image that is a portion of the image corresponding to the overlap area and is included in the second partial image, as the first overlap image; and
a second projection unit which is able to project the second partial image.
